(19) United States
(12) Patent Application Publication
(10) Pub. No.: US 2016/0080422 A1
(43) Pub. Date: Mar. 17, 2016

(54) TRANSFORMING BUSINESS POLICIES TO INFORMATION TECHNOLOGY SECURITY CONTROL TERMS FOR IMPROVED SYSTEM COMPLIANCE

(71) Applicant: International Business Machines Corporation, Armonk, NY (US)

(72) Inventors: Brian M. Belgodere, Ridgefield, CT (US); Lorraine M. Herger, Danbury, CT (US); Shakil M. Khan, Highland Mills, NY (US); Matthew A. McCarthy, Holly Springs, NC (US); William J. Rippon, Putnam Valley, NY (US)

(21) Appl. No.: 14/731,526

(22) Filed: Jun. 5, 2015

Related U.S. Application Data
(60) Provisional application No. 62/050,060, filed on Sep. 12, 2014.

(51) Int. Cl. H04L 29/06; G06N 5/04; G06F 17/30

(52) U.S. Cl. CPC H04L 63/20; G06F 17/30734; G06N 5/046; G06N 5/048

(57) ABSTRACT

A hierarchically layered group of domain-specific enhanced enterprise ontologies where each domain layer is connected to the immediate domain layer below through a layer policy/control/context translation ontology. Security controls discovery and a mapping ontology is semantically integrated to domain meta models in each layer and a corresponding security controls knowledge base.

### BACKGROUND

The present invention relates generally to the field of computer system security, and more particularly to rules compliance automation.

The focus on extracting key features from contracts and general procurement agreements has allowed organizations to go beyond simply interpreting text documents according to a set of policies, requirements, etc. The interpreted text is expressed in XML or other machine readable format and then tracked for adherence over the life of the contract. Currently, the focus in the area of infrastructure as a service (IaaS) is on procurement items, SLA's (service level agreements), and penalties for missed SLA's.

Companies are increasingly going “cloudwards” using both public providers and private datacenters because of the business agility that infrastructure as a service (IaaS) enables. Full IT automation, self-service provisioning, and metered usage billing helps companies accelerate the development of their products and services, and improves organizational efficiency. Unfortunately, many companies are struggling to accelerate the most important parts of their business due to the challenges of securing these highly dynamic environments. Use of cloud service does not automatically guarantee strong security or required compliance. Although some providers provide optional security capabilities that can be used to help reach the required security and compliance posture, it is the user's obligations to ensure secure, compliant workloads running on cloud. This is a fact which is often forgotten in the haste to bring an application or service online.

In most cases the researchers who need to move fast and implement change run into concerns from their IT and “governance” teams when they bring their ideas to the table. The groups responsible for creating and supporting applications and solutions are chartered with ensuring that data and intellectual property are secure, privacy laws and other regulations are complied with, and that the solutions are “future proof” and smart investments. The stewardship of one group to protect the company and the other to accelerate the response to change creates tension, frustration, and conflict.

### SUMMARY

According to an aspect of the present invention, there is a method, computer program product and/or system that performs the following operations (not necessarily in the following order): (i) establishing a first ontology data structure having a hierarchical description including a business-based meta model, (ii) establishing a second ontology data structure having a hierarchical description including a first external compliance dataset, (iii) determining a set of compliance constraints based on a set of inference rules and the first external compliance dataset, (iv) applying the set of compliance constraints to the first ontology data structure to establish an updated first ontology data structure, and (v) determining a degree of performance based on the updated first ontology data structure.

### BRIEF DESCRIPTION OF THE DRAWINGS

FIG. 1 depicts a cloud computing node used in a first embodiment of a system according to the present invention;

FIG. 2 depicts an embodiment of a cloud computing environment (also called the “first embodiment system”) according to the present invention;

FIG. 3 depicts a first set of abstraction model layers used in the first embodiment system;

FIG. 4 is a diagram showing information that is helpful in understanding the business system and corresponding layer translation ontology according to the present invention;

FIG. 5 is a flowchart of a first method according to the present invention;

FIG. 6 is a diagram showing information that is helpful in understanding embodiments of the present invention;

FIG. 7 is a flowchart of a first method according to the present invention;

FIG. 8 is a block diagram of a second embodiment system according to the present invention;

FIG. 9 is a diagram showing an example compliance-ontology according to the present invention;

FIG. 10 is a diagram showing an example compliance checking process according to the present invention;

FIG. 11 is a flowchart of a second method according to the present invention;

FIG. 12 is a block diagram of a third embodiment system according to the present invention;

FIG. 13 is a block diagram of a fourth embodiment system according to the present invention.

### DETAILED DESCRIPTION

A hierarchically layered group of domain-specific enhanced enterprise ontologies where each domain layer is connected to the immediate domain layer below through a layer policy/control/context translation ontology. Security controls discovery and a mapping ontology is semantically integrated to domain meta models in each layer and a corresponding security controls knowledge base. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

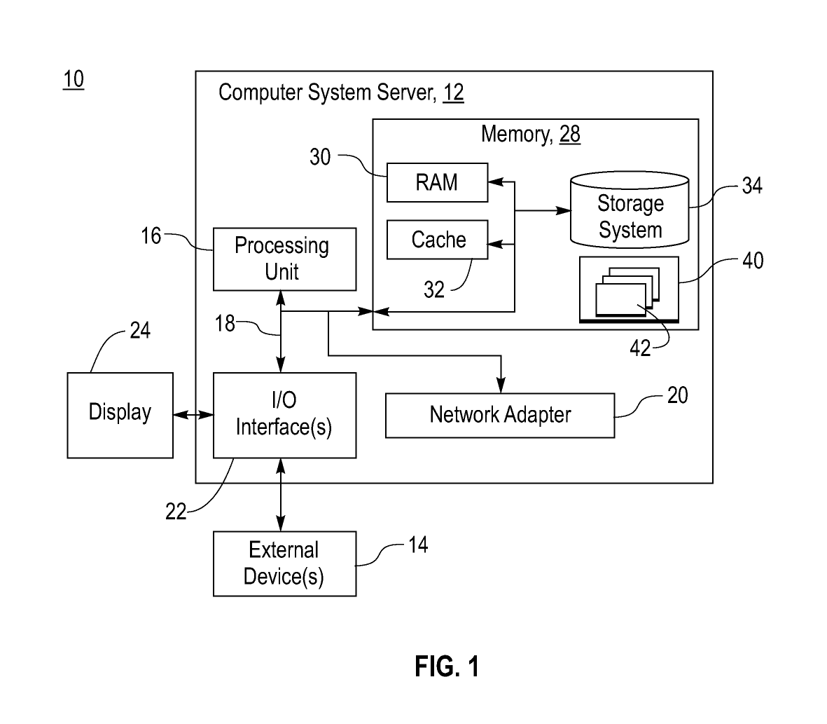

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

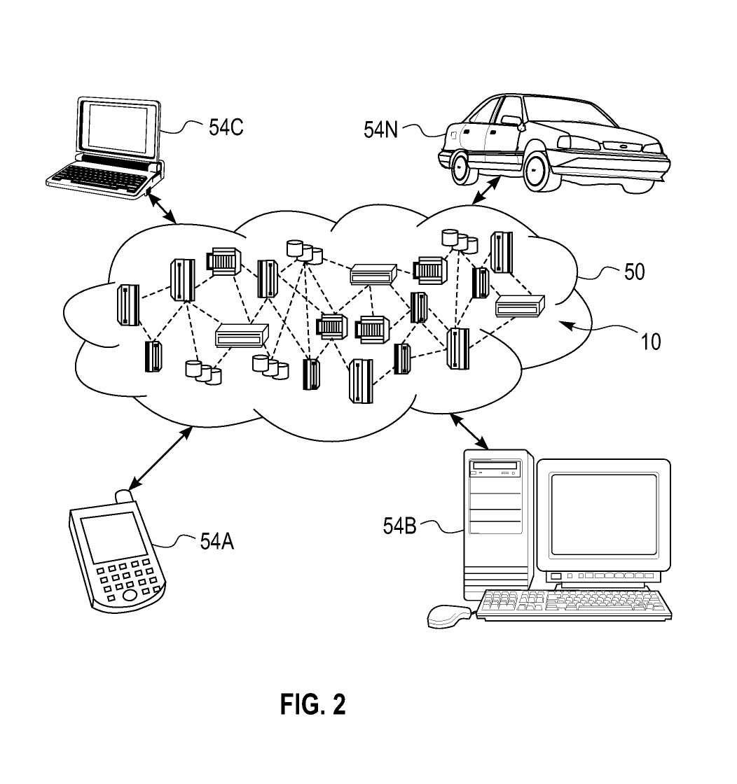

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

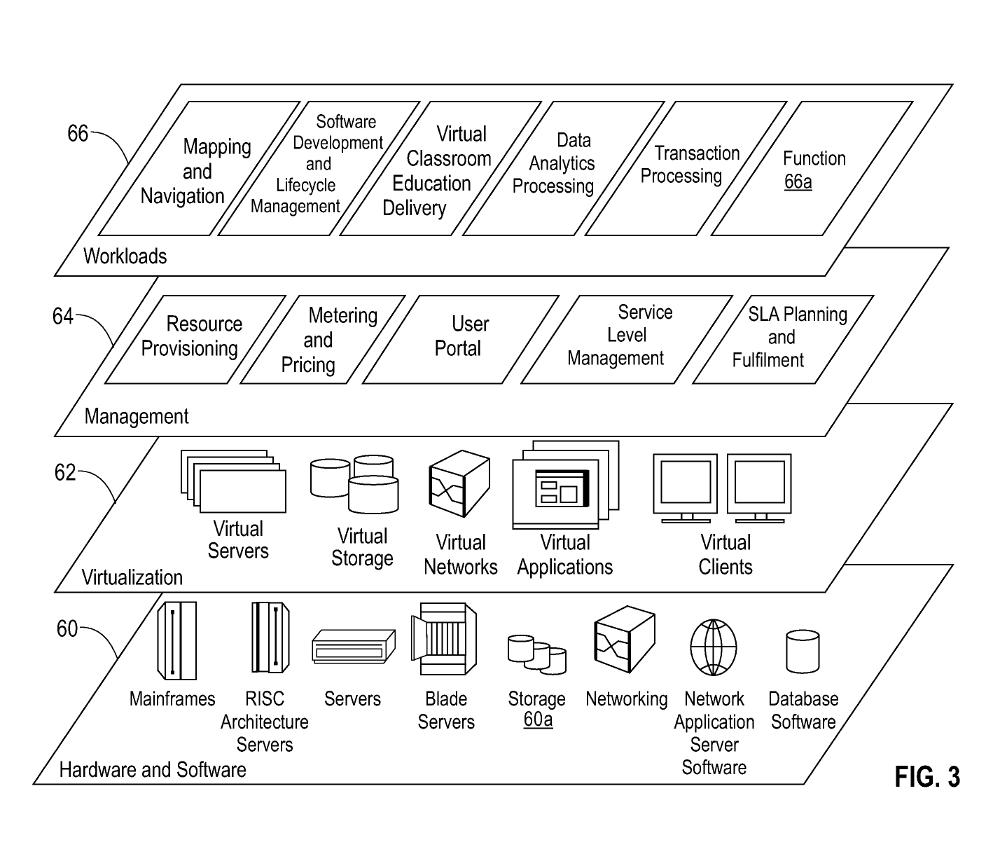

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes; RISC (Reduced Instruction Set Computer) architecture based servers; storage devices; networks and networking components. In some embodiments software components include network application server software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and functionality according to the present invention (see function block 66a) as will be discussed in detail, below, in the following sub-sections of this Detailed description section.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

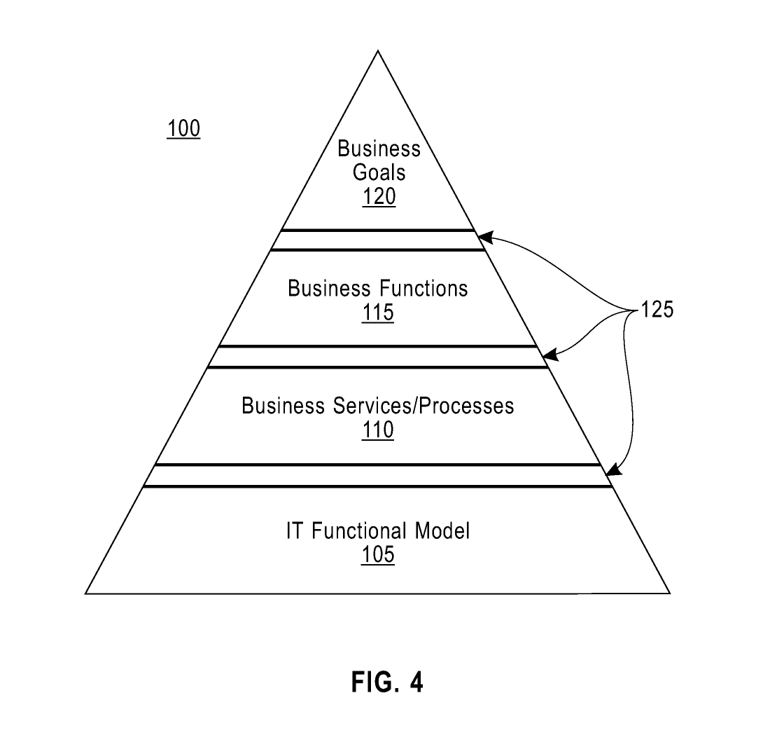

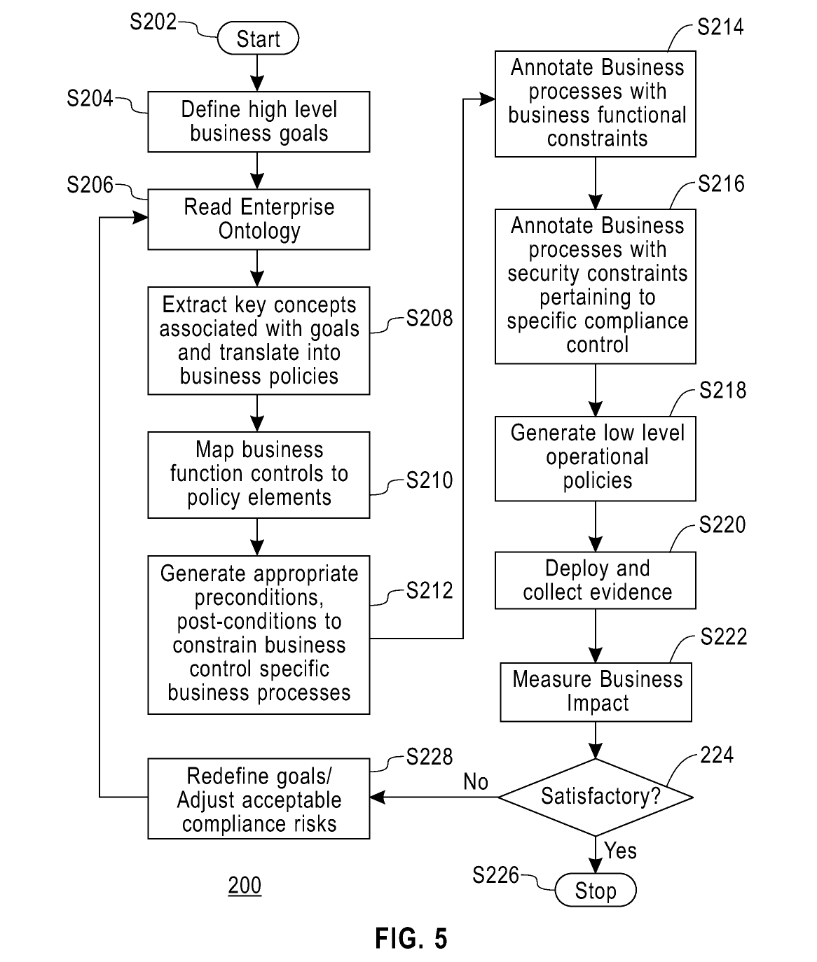

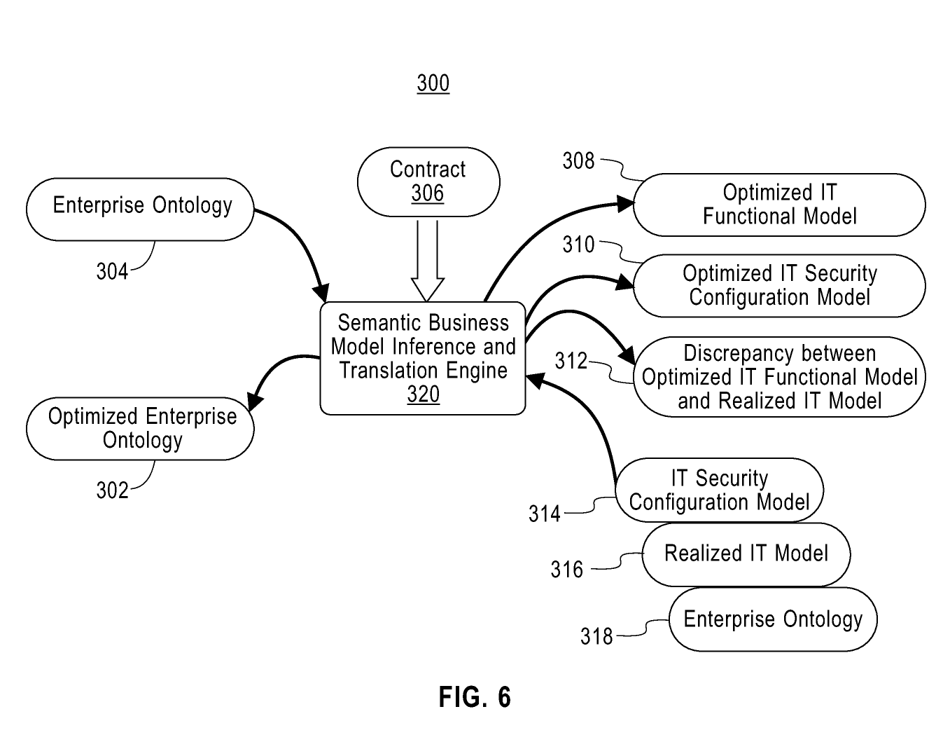

FIG. 4 shows diagram 100 depicting a translation ontology according to some embodiments of the present invention. FIG. 5 shows flowchart 200 depicting a method according to the present invention. FIG. 6 shows process diagram 300 depicting the operation of a semantic business model inference and translation engine according to some embodiments of the present invention.

In the discussion that follows, an example method is illustrated where a translation ontology is layered according to high level business policies that are filtered into verifiable categories including: an IT functional model 105; business services and/or processes 110; business functions 115; and business goals 120. The translation ontology layers 125 translate policy, control, and/or context according to high level business policies. These filtered business functions guide domain-specific activities, functions, roles, and/or scope. Further, verification of regulatory compliance is performed against one or more domains. In some embodiments, changes in business policies, business-specific policies, and/or business-specific metrics are introduced to develop an optimized security configuration.

A dynamic enterprise is comprised of hierarchical functional layers where business reference model of ideas and goals starts at the top, followed by business functions, business processes, business services, with the IT functional model and its realization at the bottom. Each layer is comprised of cohorts of domain meta models that represent domain scope, functions, and policies. Policies defined at the top layer to guide business goals, ideas, and functions become increasingly IT implementation specific as they move toward each successive bottom layer.

Governance, risk, and compliance activities in an enterprise rely on measuring the state of compliance of various business processes, oftentimes using security controls derived from regulatory policies. These security controls may be implemented in variety of ways. Now, in an ever evolving enterprise, business events arising outside IT may affect the consistency, definition, and implementation of the security controls. For example, a merger between a business-process-oriented company and a function-oriented company may lead to non-compliance pertaining to business processes, security, etc. Understanding the security compliance behavior through the lens of regulatory policy and within the containment of business process models and IT-oriented models may not be sufficient.

Referring now to FIGS. 5 and 6, an example method is described according to flowchart 200, which is performed, at least in part, according to process diagram 300. Processing begins at step S202 and proceeds to step S204, where high level business goals are defined. In this example, contract 306 is the basis for the high level business goals. Processing proceeds to step S206, where the current enterprise ontology 304 is read into semantic business model inference and translation engine (also referred to herein as the inference engine) 320 for processing the high level business goals defined in step S204.

Processing proceeds to step S208, were key concepts associated with business goals are extracted and translated into business policies by the inference engine. Processing proceeds to step S210, where business function controls are mapped to policy elements according to, for example, IT security configuration model 314 and realized IT model 316. Processing proceeds to step S212, where pre-conditions and post-conditions are generated, as appropriate, to constrain business-control-specific business processes.

Processing proceeds to step S214, where certain business processes are annotated with corresponding business functional constraints as generated in step S212. In that way optimized IT functional model 308 is generated. Processing proceeds to step S216, where certain business processes are annotated with security constraints corresponding to specific compliance control. In that way, optimized IT security configuration model 310 is generated.

Processing proceeds to step S218, where low level operational policies are generated, based on the annotated business processes. Processing proceeds to step S220, where policies are deploy and evidence is collected during business operations. Discrepancy 312 is generated where the discrepancy is between the optimized IT functional model (308) and the realized IT model (316). Processing proceeds to step S222, where the business impact of the optimized business policies are measured.

Processing proceeds to step S224, where it is determined whether the business impact is satisfactory. If the business impact is satisfactory, optimized enterprise ontology 302 is complete and processing follows the “yes” branch to step S226, where processing stops. If the business impact is not satisfactory, processing follows the “no” branch to step S228, where business goals are redefined and/or acceptable compliance risks are adjusted. Processing then returns to step S206, where the latest enterprise ontology is read into the inference engine. Steps S207 through S224 are repeated according to this example, until the business impact is satisfactory, where processing follows the “yes” branch and stops.

Some embodiments of the present invention are directed to a semantic representation of the regulations and an enterprise reference architecture for the flexibility and the extensibility needed to model continuously-evolving enterprise domains, and compliance regulations. In that way, modeling may reveal the impact on business goals and ideas as they relate to the state of compliance.

Some embodiments of the present invention are directed to a hierarchically layered group of domain-specific enhanced enterprise ontologies where each domain layer connected to immediate domain layer below through a “Layer policy/control/context translation ontology” (referred to above as “translation ontology layers 125”). Security controls discovery and a mapping ontology is semantically integrated to domain meta models in each layer and a corresponding security controls knowledge base. Some embodiments of the present invention are directed to a “compliance-evaluation-process ontology” that permits us to update dynamic compliance attributes/constraints from external sources to produce a continually updated degree of (security) performance for the enterprise by imposing those compliance attributes/constraints over the enterprise ontology using the inference engine.

### III. Further Comments and/or Embodiments

Some embodiments of the present invention recognize the following facts, potential problems and/or potential areas for improvement with respect to the current state of the art: (i) reliability, security, and compliance stand as barriers to fully realizing the potential of IaaS implementations in a business environment; (ii) conventionally, security and compliance measures are treated as only an “afterthought;” (iii) conventional ad hoc security and compliance solutions are bolted onto existing infrastructures, creating obscure and non-repeatable tactical solutions that are: (a) sub-optimal, (b) fail to meet contractual requirements, and/or (c) fail to manage risk appropriately; (iv) users typically lack expertise in security and compliance; (v) failure to communicate changes in regulations and/or other compliance controls to users, that is, outside of the traditional security and compliance functions, leads to contextually invalid security understanding and subsequent invalid implementation; (vi) a lack of automation and tooling in the areas of security, compliance and/or validation with respect to business agreements, policies and/or standards is responsible for improper continuous compliance; (vii) the lack of proper security and/or compliance measures lead to data theft and/or intellectual property theft; (viii) the effects of improper implementation of security measures include corporate reputations and the financial impact of breached contracts; (ix) information technology (IT) solutions often meet only certain aspects of business requirements, falling short of a completely integrated security and compliance operation; (x) service providers oftentimes utilize operating agreement contracts that cover security and compliance requirements in a manner similar to procurement, pricing, and/or SLA specifications.; (xi) the security and compliance requirements introduced from contracts with enterprise clients are also defined in text which is not easily interpreted into IT requirement policies; (xii) aspects of a contract other than the security and compliance areas have been interpreted with xml formats to interpret and apply those aspects; and/or (xiii) security incidents with a data breach present a wide array of legal problems for victim companies (data breach notification laws pertaining to definition of personal information, identification of notification triggers, method of notification, content of notification, determination of time, and acceptable delays vary widely across legal jurisdictions).

Some embodiments of the present invention overcome several gaps in state of the art model-driven compliance. The gaps include: (i) the IT functional models are evaluated against statically-defined high level compliance policies to assess impact on low level policies and state of compliance only; (ii) business demand is limited to changing the IT functional model and subsequently, the compliance state, which is corrected through manual changes in low level IT policies; (iii) IT-Business alignment is interpreted through only an IT-functional model; (iv) criteria for satisfied compliance focuses only on evidences between IT system policies and documented security requirements (compliance policies); (v) there is no notion of an optimized compliance configuration based on a tolerance for risk and a budget for security; (vi) ignoring operational goals, such as sustainability, performance, and/or profitability.

Some embodiments of the present invention are directed to interpretation of the security and compliance elements of a contract through automatic extraction, interpretation, and application via a compliance as a service (CaaS) model.

Some embodiments of the present invention define the tolerance for risk and the budget for security though a contracts and enterprise architecture, or ontology. Some embodiments of the present invention are directed to an iterative correspondence between an enterprise operational universe and a compliance as a service (CaaS) solution for both negotiating and implementing an optimized compliance configuration that balances tolerance for risk and budget for security. Some embodiments of the present invention are directed to a fully-automated risk assessment and remediation solution in a Compliance as a Service (CaaS) model. The CaaS model provides for a dynamically-derived IT functional model from the enterprise ontology that essentially captures organizational goals and/or the operational universe. A contract model within the enterprise ontology decomposes portions of contracts that will require IT commitments. These contracts are decomposed into high level policies that are dynamically bound to specific security requirements.

Some embodiments of the present invention are directed to integrating enterprise ontology and enterprise contacts into model-driven compliance automation for negotiating and/or implementing a cost-effective compliance configuration in an iterative manner. Some embodiments of the present invention provide both content analysis of negotiated documents (e.g., contracts, statements of work, documents of understanding) that provides visualization, and assisted analytics to drive domain-specific (e.g., IT security and IT compliance) refinement for more specific parameters of the agreement to match the needs of the party. Further, automatic delivery of a set of policy and provisioning descriptors (structured, machine-readable language) to drive delivery of the service(s) and operation of the customer engagement operate to ensure continuous compliance. The policy is mapped to security controls for specific compliance goals that are bundled according to the class of information services. In that way, the policy is reconciled with IT rules.

FIG. 6 is a flowchart depicting method 600 for contract analytics. Decomposing a portion(s) of a contract that requires IT commitments (such as security and compliance) into high level policies and requirements begins, in this example, with content analysis of enterprise ontology elements including, for example, enterprise profile, services, and rules (602). Also included in the decomposition activity is analysis based visualization of IT relevant parameters including parameterized operational criteria for sustainability, performance, and/or profitability (for example, inputs such as costs, tolerance for security, and budget for security) and domain expert involvement where IT professional(s) modify contract(s) via a visualization assistant (604, 606). Until a contract modification is made, the method of this example returns to step 602, followed by step 604. When a contract modification is made, a revised version of the contract is made having known, accepted IT parameter(s) (608). Accordingly, after an additional revisions are made by other parties, deal-specific artifacts are generated (610, 612). Processing proceeds to communicate IT implementation details, project-specific policies, and/or IT security and compliance requirements (614).

When communication of step 614 is received, an IT functional model is dynamically derived with the help of an enterprise ontology and various artifact generated from contract analytics. That is an IT instance is created from project-specific polices, IT security and compliance requirements, and an implementation model (624). The IT functional model dynamically binds with security requirements and security implementations to generate policies for deployment. Specifically, high level operational policies are generated and managed (626), contextual references are disambiguated and policy is mapped to security controls (628), and security controls are annoted with security requirements to generate low level policies (630).

The policies are deployed and evidences are collected during operation (632). The evidences are computed to compare against parameterized enterprise operational goals and/or requirement thresholds (634). If drift is detected in the comparison step (636), then contractual item(s) and/or enterprise ontology modification is suggested based on reading the enterprise ontology (616) (branch 1) and reading the contract model (618) (branch 2). According to this example method, one or both of the modification actions will be taken before ending the process due to no drift detected (see 636). Method 600 essentially iterates until the measures taken fall within a pre-defined tolerance range for the threshold requirement.

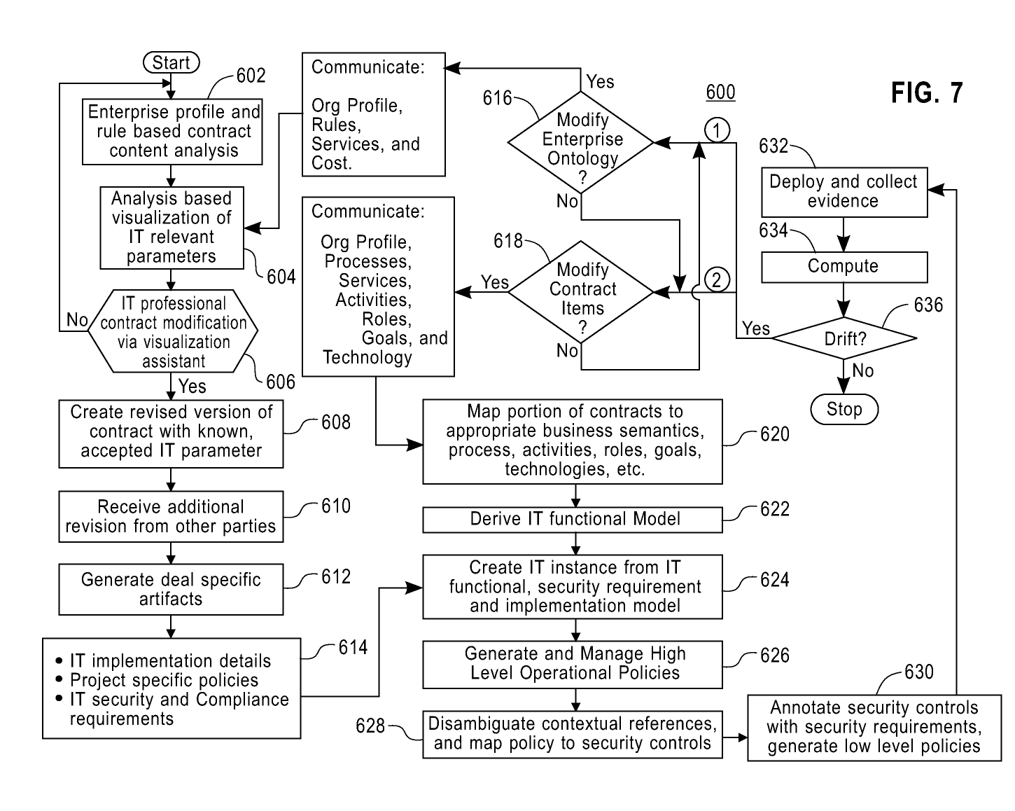

FIG. 7 is a block diagram for CaaS system 700 that performs, at least portion(s) of method 600, according to the present invention. Components of system 700 include: enterprise ontology sub-system 702; business process model(s) 704; data model(s) 706; organizational hierarchy(ies) 710; contract model(s) 708; management platform 712; policy program 714; analytics module (“mod”) 716; orchestration mod 718; lifecycle management mod 720; extended store 722; compliance management database (CMDB) 724; resource description framework (RDF) store 726; translation and dissemination module 746; controls program 728; event correlation mod 730; forensic analysis mod 732; root cause analysis mod 734; drift analysis mod 736; policy mapping mod 738; control mapping mod 740; provenance mod 742; security analytics mod 744; messaging bus 748; metalayer mod 750; event collection framework 758; network sub-system 760; virtual private network (VPN) mod 762; host IDS mod 764; network IDS mod 766; firewall mod 768; controller mod 770; operations management sub-system 772; asset management mod 774; identity mod 776; patch management mod 778; problem management mod 780; vulnerability mod 782; infrastructure and applications sub-system 784; application events mod 786; topology mod 790; configuration mod 794; infrastructure health mod 788; application dependency mod 792; brokerage sub-system 752; IaaS provisioning mod 754; platform as a service (PaaS) provisioning mod 756; and physical datacenter 796.

Enterprise ontology sub-system 702 and the corresponding contract analytics modules, such as business process model(s) 704, includes domain experts, enterprise ontology (including, for example, enterprise profile, services, and rules), and/or parameterized operational criteria for sustainability, performance, and/or profitability (for example, inputs such as costs, tolerance for security, and budget for security) that are considered in decomposing a portion(s) of a contract that requires IT commitments (such as security and compliance) into high level policies and requirements.

Policy lifecycle management 720 provides for describing the underlying security, compliance, and risk requirements as declarative policy items, via policy program 714. Policy items are mapped to the security controls via controls program 728 and checked periodically through management workflows to ensure policy adherence. Changes in regulations affect both the requirements and the mapping of security controls and policy items. Therefore policy program 714 includes a process, or module, for controlling its overall lifecycle, that is, lifecycle management module 720.

Controls program 782, also referred to as CaaS Controller, is the centralized management system for security provisioning. The CaaS controller co-ordinates with various distributed policy-aware components via policy program 714 to maintain the desired compliance state in a fully automated fashion. The CaaS controller continuously polls filtered monitoring data through event collection framework 758. The controller indexes and aggregates the machine produced data, applies security control contexts, and the data persists in repository, or extended store, 722. If components are determined to be out of policy, the controller invokes the management plan to remediate the non-compliance. All the compliance state computations are also validated by a metadata driven controller function, compliance provenance module 742, also referred to as the compliance provenance function. The controller also provides sophisticated agentless monitoring for compromised virtual machines via forensic analysis module 732 and root cause analysis module 734. Finally, the controller provides functions to formalize knowledge derived from trend analysis, via, for example, big data security analysis module 744, and applies the formalized knowledge to predict compliance drift. via drift analysis module 736.

Policy and management plan translation and dissemination framework, or module, 746 supports management plans in the orchestration framework 718 that are annotated with security controls in an abstract manner. In order to remediate a component deemed out of policy, there is a need for a semantic layer which knows the component domain, domain specific security control, domain specific policy and domain specific action to take to bring the component out of non-compliance. Success of compliance as a service (CaaS) depends on the policy awareness of the components with which the CaaS controller interacts. In reality, it is impractical to expect policy awareness from vast swaths of domain solutions that make up the CaaS solution. Most of the solutions capture policies in the form of static configuration, failing to expose any API to manipulate those policies. The semantic layer also has the function to convert high level policies into an XACML format and to domain-specific source control configurations.

Event collection framework 758, enables modularized solutions to collect and correlate events and alerts from key domains in a common format. Even correlation is governed by event correlation module 730. The framework also allows defining domain-specific event filters created through a common user interface.

IaaS provisioning audit trail 754 introduces such a dynamic environment and scale of operation that the traditional operations model is inadequate to meet the operations requirements. The IaaS audit trail also, redistributes responsibilities from the lower level of the stack to the platforms and applications of CaaS system 700. Operations succeed to the extent that there is collaboration with developers and/or participates in the development of applications that self-monitor and self-heal. This monitoring and healing provides a powerful framework to make compliance-specific security controls available to policy-aware applications in the form of fully traceable configuration parameters. Audit logging of provisioning activities are automatically supported to provide information for security control.

PaaS provisioning audit trail 756 ensures, according to topology and orchestration specification for cloud applications (TOSCA), the portability of a complex cloud application running on complex software and hardware infrastructures. TOSCA's abstraction level provides a way to describe both applications and infrastructure components at a high level, which enables cloud orchestration that can leverage CMDB 724 for the infrastructure layer. Assembling and orchestrating virtual images into larger structures, and then relating these to existing infrastructure, produces a useful audit trail that is mined to unearth process flaws that could lead to non-compliance. Also, through TOSCA's lifecycle support beyond deployment, it is possible for drift module 736 to provide historical data when measuring topology drift.

The information technology infrastructure library (ITIL) is a framework of best practice approaches intended to facilitate the delivery of high quality information services. In order to facilitate the integration and automation of ITIL best practices, ITIL specifies the use of a configuration management database (CMDB) to leverage a single source of information for all configuration items (CI) such as computer system, operating systems, and software installation. The configuration management process includes performing tasks such as identifying configuration items and their relationships, and adding them to the CMDB. The contextual mapping of CIs stored into CMDB provides the basis for converting the information into a knowledge graph (RDF) based Semantic model. This allows us to traverse the relationship to form pattern-based queries and deduce other implicit relationships, which may not be stored. This permits meshing an external information graph with the CMDB knowledge graph through entailment. In the presence of partial information (an element of volatile unstructured data) the output is still a consistent RDF model, which can be successfully processed. CMDB acts as a trusted information management framework for master configuration data.

An example of the agility of cloud computing is the adoption by enterprises of the software-defined datacenter (SDDC) model, in support of the changing workloads and dynamic patterns of the enterprise. Capabilities such as a service catalog with standardized offerings, tiered service level agreements (SLA), automated workload aware provisioning in private, public clouds, hybrid clouds, proactive incident and/or problem management, IT cost transparency, and IT cost chargeback operated to unlocked the efficiency, agility, and benefits of cloud computing. Still, reliability, security, and compliance concerns impede businesses from reaping the full benefit of the cloud.

Some embodiments of the present invention are directed to overcoming some present challenges by building an IaaS integrated with a fully automated risk assessment and remediation engine in a “Compliance as a Service (CaaS)” model. CaaS treats non-functional security and compliance requirements in a non-proprietary and interoperable way. CaaS functional activities are controlled by a set of dynamic policies. An analytics function constantly, or continuously, interfaces with security information and event management (STEM) tools, audit logging, etc., to measure the drift and then disseminate policy commands to the policy aware security control components, applications, IaaS, Platform as a Service (PaaS) to fix the drift. IaaS and PaaS solicit guidance during provisioning to selected target environment based on compliance requirement and trend analysis. This “infrastructure as code” model (IaaS) integration with “compliance as code” model (CaaS) bridges the gap between agility and security.

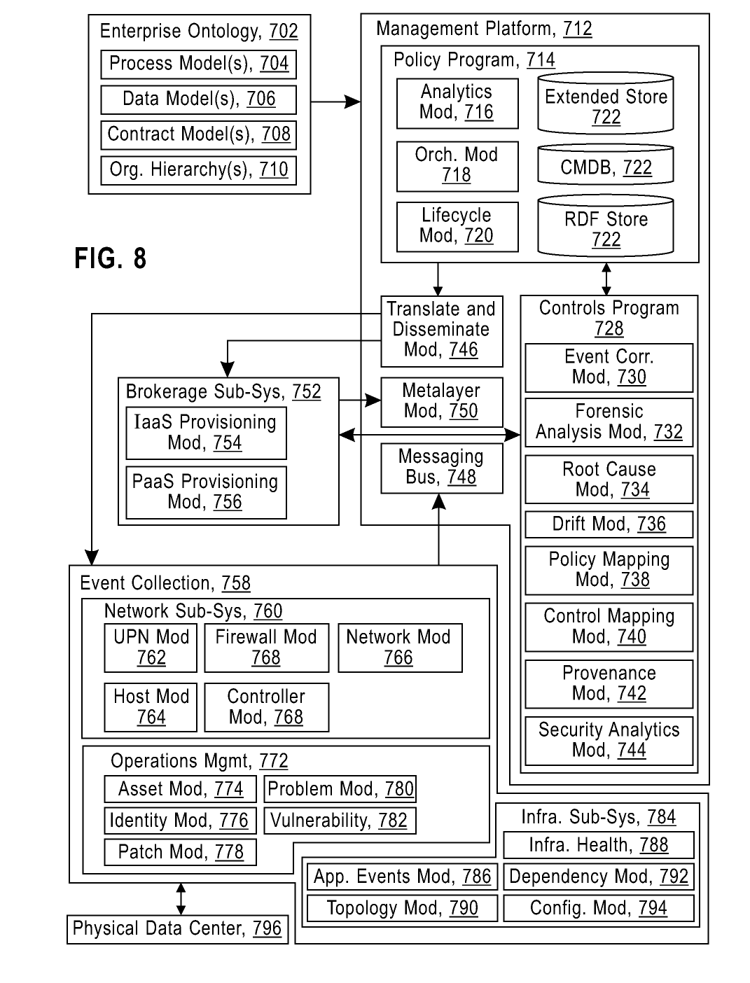

FIG. 8 shows compliance-ontology 900, a meta model for compliance validation and evaluation according to an embodiment of the present invention. The compliance ontology includes: ontology 900; regulation 902; compliance acceptance standard 904; regulation-constraint 906; evaluation-criteria 908; deontic-constraint 910; analysis-object 912; analysis-task 914; role 916; investigation personnel 918; law enforcement 920; analysis-item-checking-action 922; checking-result 924; evaluation-task 926; evaluation-result 928; compliance-report 930; instance 931; Title 15 of United States Code 932; data-security-task1 934; data-breach-notification-analysis-task1 936; john doe 938; data-sensitivity-checking-action_940; data-sensitivity-checking-result_942; data-sesitivity-evaluation-Action_944; data-sensitivity-evaluation-result_946; data-breach-notification-analysis-report1 948.

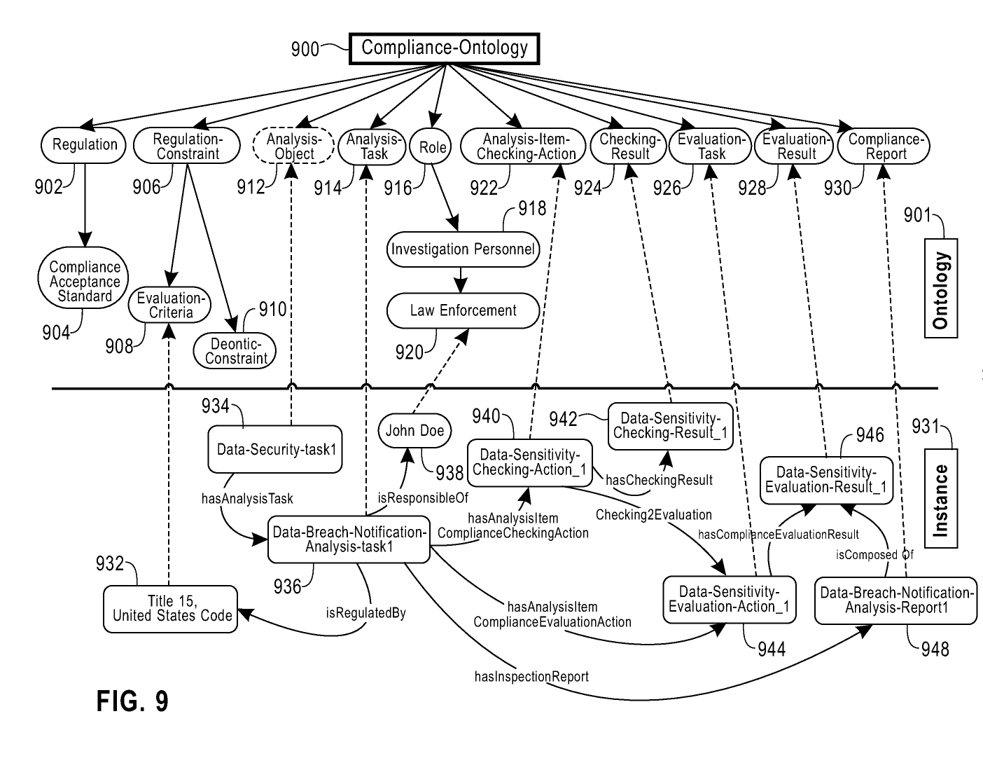

FIG. 9 shows compliance checking ontology 1000 for compliance checking according to an embodiment of the present invention. The compliance checking ontology includes: parameter 1002; evaluation-criteria 1004; evaluation-task 1006; evaluation-result 1008; compliance-report 1010; regulation-constraint 1012; checking-result 1013; analysis-item-checking-action 1014; role 1016; regulation 1018; deontic-constraint 1020; analysis-task 1022; analysis-object 1024; object set 1026; resource 1028; product 1030; activity 1032; and process model 1034.

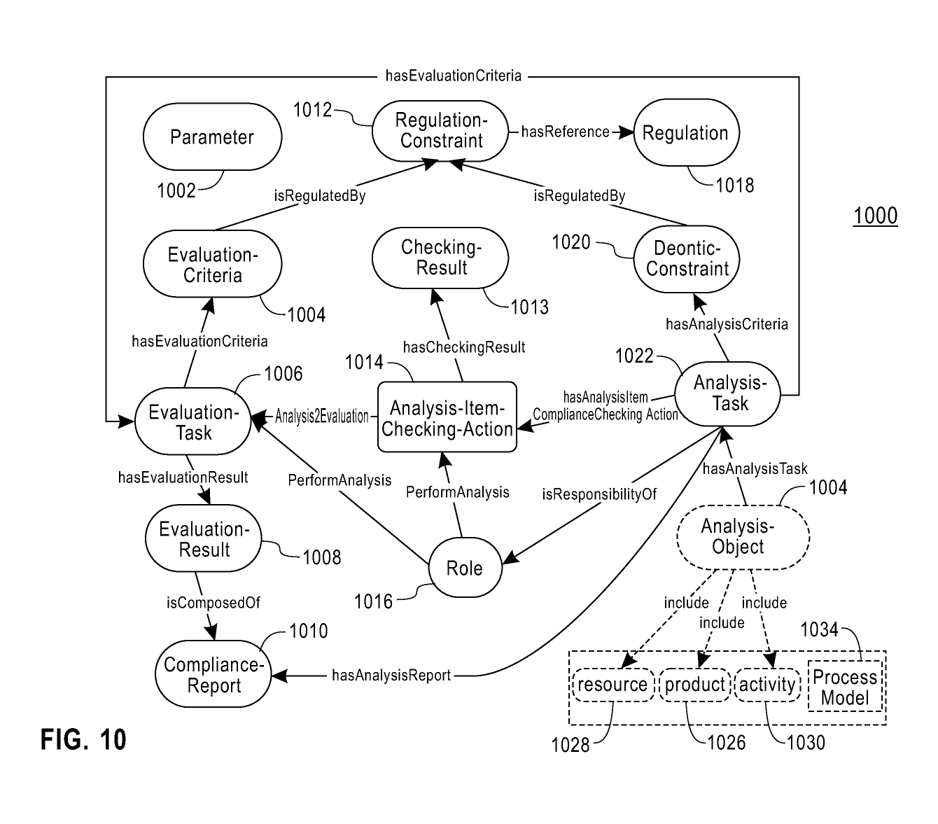

FIG. 10 is a flowchart depicting data breach notification analysis process 1100 according to the present invention. In the example discussed on the following paragraphs, reference will be made to compliance-ontology 900, compliance-checking ontology 1000, and the process flow of data breach notification analysis process 1100. It should be noted that certain information is drawn from state statutes pertaining to definitions of personal information, determination of notification triggers, and content of notification.

In this example, regulation-constraint items 906 are modeled into OWL axioms and SWRL rules based on compliance-ontology 900. Data-sensitivity-assessment-activity 1102 from data breach notification process flow 1100 illustrates how jurisdictional regulatory constraints are applied to validate compliance of an activity result when an incident is identified (1101). Some embodiments of the present invention include incident timestamps to determine acceptable delays in response time. Compliance checking ontology 1000 serves as a meta model, defining the concepts and relations related to the IT security regulatory compliance checking. Analysis-task 1022 is the exemplary class in this example ontology. During incident investigation activity 1104, analysis-task items 1022 are established according to regulation-constraint items 1012, which is task-specific. The analysis-task items may be related to analysis-object items 1024 through the “hasAnalysisObject” property. The “hasAnalysisObject” property indicates that the analysis-object will be inspected to verify compliance to the relevant regulation constraints through the execution of the analysis-task. The analysis-object refers to any concepts governed by regulations. An analysis-object indicates set of objects 1026 to be inspected, for example, in the case of IT security, compliance to the regulatory requirements domain includes: (i) identification of activity 1032; (ii) evaluation of the activity; (iii) remediation processes (activities and procedures) 1034; (iv) data security products 1030 used in the analysis; and (v) data security resources 1028 used in analysis. An analysis-object may include a set of violation analysis items (not shown). These analysis items are generally identified from the regulation provisions. Alternatively, user-specified items are included.

Given a section of code, or other regulations, set of objects 1026, or analysis items, may include determination of personal information, identification of notification triggers, method of notification, content of notification, and determination of time and acceptable delays. As stated earlier, specific requirements vary widely across jurisdictions. This information is collected and classified as an analysis-object for a given activity.

Continuing with the example, analysis-task 1022 needs data classified as analysis-item-checking-action items 1014 to test and collect the conformance information, or data, for the analysis items. Each analysis-item-checking-action has a corresponding checking-result item 1013. The checking-result items represent the actual information collected with respect to violation, conformance, and/or compliance to regulations. Similarly, analysis-task items 1022 need evaluation-task items 1006 to evaluate the provenance of the analysis items in accordance with evaluation-criteria items 1004. The evaluation-criteria items are imposed by the regulation provisions, or set by domain experts. In light of checking-result items 1013 and evaluation-criteria items 1004, the evaluation-task items provide for judgment as to whether the analysis items are compliant with the regulation constraints. Each evaluation-task item has a corresponding evaluation-result item 1008. Compliance-report items 1010 include the evaluation-task items and the evaluation-result items. The compliance-report of a particular analysis-task for the corresponding analysis-object can be documented, based on the evaluation-result items of all the inspection items.

In compliance ontology 900, regulation-constraint items 906 constitutes the bulk of the analysis knowledge because the focus is on regulation-based compliance analysis. Each constraint comes from the corresponding provision text in regulations. The relation “hasRegulation” associates the constraint with the provision text from which the constraint is extracted. Meanwhile, an analysis-task item must be assigned to role 1016 as its responsibility. The role item represents who performs the analysis-item-checking-action and the evaluation-task to accomplish the analysis-task. In addition, parameter items 1002, such as business process parameters, IT functional parameters, IT realization parameters, and user behavioral parameters, are used to depict the compliance features/state, in the IT security regulatory compliance domain.

Analysis-object items 1024 may include: (i) an IT functional model; (ii) an IT security model; (iii) an IT configuration model; (iv) IT security product(s); (v) business processes; and/or (vi) user activities. In this example, each main concept indicates one facet of the analysis objects and each concept can be modeled as the IT security process ontology. In compliance-ontology 900, analysis-object concepts 912 (show in a dashed line) are also the concepts of the IT security process model. Through the analysis-object concept, the compliance ontology for compliance checking can interact with the IT security process model. This meta model provides both general and common terms as well as relationships common to the IT security compliance checking against the regulatory requirements domain. With reference to the meta model, the specific domain model for security compliance checking is obtained via specializing and instantiating the generic concepts and relations in the meta model. The meta model is not limited to any specific IT Security domain. Therefore, the meta model is reusable, being independent of any specific security implementation. With further reference to the meta model and the compliance-ontology, the constraints knowledge imposed by the regulations is clearly and unambiguously defined such that may be interpreted by a machine.

Data breach notification activity 1108 assures notification compliance according to corresponding regulations. For example, based on compliance-ontology 900, regulation-constraint items 906 are modeled into OWL axioms and SWRL rules. The process including data-sensitivity-assessment-activity 1102 shows how jurisdictional regulatory constraints are applied to validate activity result compliance.

Based on compliance ontology and the IT security process, each compliance analysis task can be modeled as an ontology instance. As shown in FIG. 8, the compliance-ontology instance is used as a reference in compliance checking to identify an incident according to step 1101 of sensitive data breach notification process 1100. In order to make the ontology knowledge understandable to both machines and human beings, the ontology knowledge is described in OWL. OWL is a W3C recommended language for ontology representation on the semantic web because it offers a relatively high level of expressivity while still being decidable. In addition, OWL, as a formal language with description logic based semantics, enables automatic reasoning about inconsistencies of concepts, and provides RDF/XML syntax to represent ontology knowledge.

Some embodiments of the present invention require that one analysis-task has at least one analysis-item-checking-action. Accordingly, a first axiom is analysis-task hasAnalysisItemComplianceCheckingAction only Analysis-Item-Checking-Action and a second axiom is Analysis-Task hasAnalysisItemComplianceCheckingAction minimum one. The following pseudo-code reflects this requirement:

```
<owl:Class rdf:ID=“Analysis_Task”>
<rdfs:subClassOf>
  <owl:Restriction>
  <owl:allValuesFrom>
      <owl:Class rdf:ID=“Analysis-Item-Checking-Action”/>
  </owl:allValuesFrom>
  <owl: onProperty>
      <owl:ObjectProperty
rdf:ID=“hasAnalysisItemComplianceCheckingAction”/>
  </owl: onProperty>
  </owl:Restriction>
</rdfs:subClassOf>
<rdfs:subClassOf>
  <owl:Restriction>
  <owl:minCardinality rdf:datatype= http://www.w3.org/2001/XMLSchema#int>1
</owl:minCardinality>
  <owl: onProperty>
      <owl:ObjectPropertyrdf:about=
“#hasAnalysisItemComplianceCheckingAction”
/>
    </owl:onProperty>
  </owl:Restriction>
</rdfs:subClassOf>
</rdfs:subClassOf rdf:resource=“http://www.w3.org/2002/07/owl#Thing”/>
</owl:Class>
```

Now, where a first constraint is “Personal Information must contain consumer's name and at least one of the following information: Social Security Number, Driver's License Number or State Identification Card Number, Credit card number, debit card number, account number and any codes or password (from State Data Breach Notification Law),” the state requirement is modeled in the following axiom, according to some embodiments of the present invention.

```
  <owl:Class rdf:ID=“Personal_Information”>
  <rdfs:subClassOf>
    <owl:Restriction>
      <owl:onProperty rdf:resource=“#consumer_fname”/>
      <owl:minCardinality
  rdf:datatype=“http://www.w3.org/2001/XMLSchema#int”>1</owl:minCardinality>
      </owl:onProperty>
    </owl:Restriction>
  </rdfs:subClassOf>
  <owl:unionOf rdf:parseType=“Collection”>
  <owl:Class rdf:about=“#Social_Security_Number”/>
  <owl:Class rdf:about=“#Driver_License_Number”/>
  <owl:Class rdf:about=“#Credit_Card_Number”/>
    . . .
  </owl:unionOf>
  </rdfs:subClassOf rdf:resource=“http://www.w3.org/2002/07/owl#Thing”/>
  </owl:Class>
A further axiom follows:
  <owl:Class rdf:ID=“Breached_Information”>
    <rdfs:subClassOf>
      <owl:Restriction>
      <owl:onProperty rdf:resource=“#hasType”/>
      <owl:hasValue rdf:resource=“#personal_information”/>
    </owl:Restriction>
  </rdfs:subClassOf>
  </owl:Class>
```

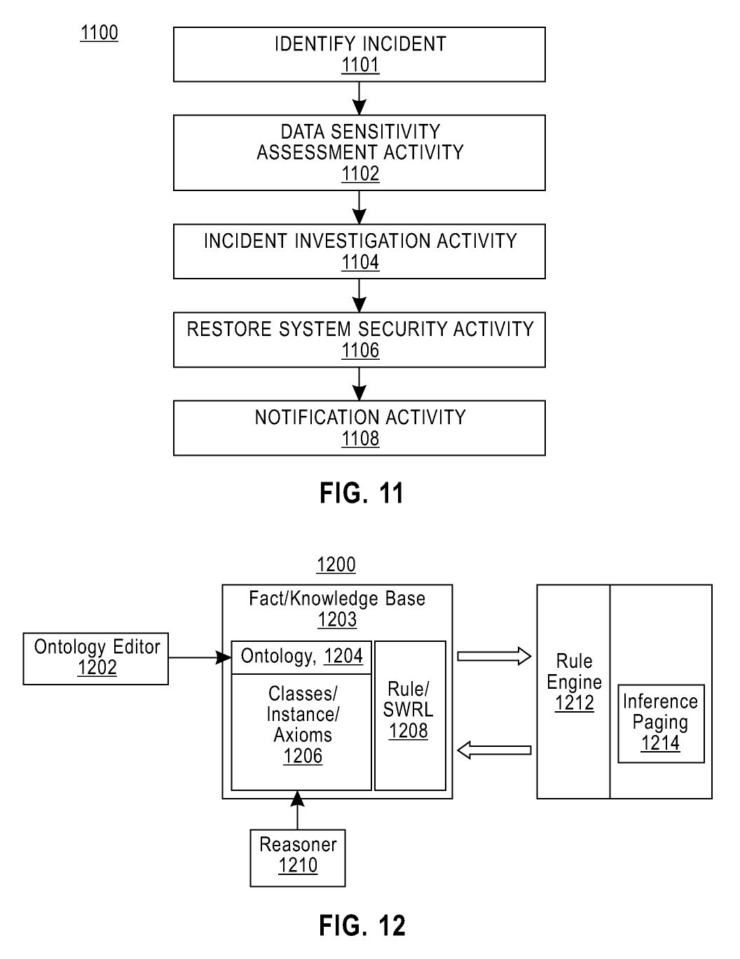

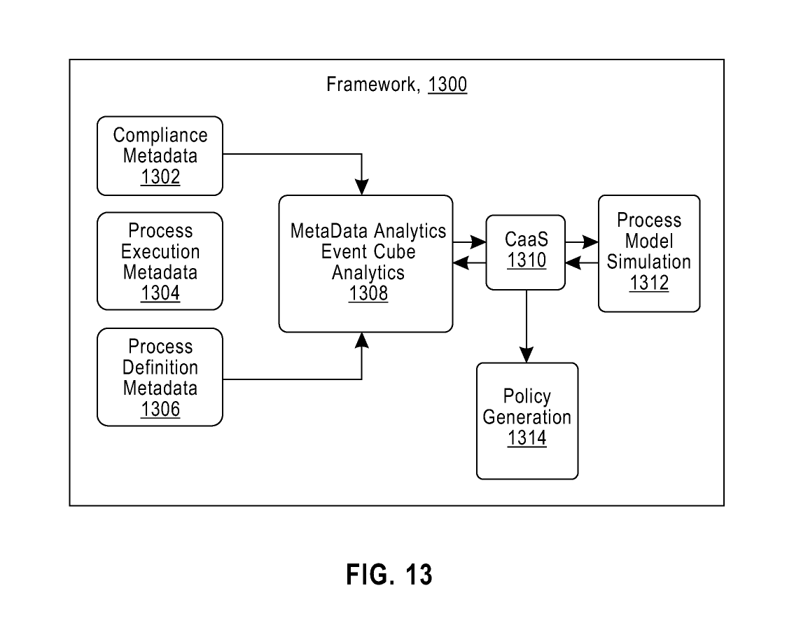

Referring now to FIG. 11, soft environment 1200 is an example implementation for practicing some embodiments of the present invention. Ontology editor 1202 enables a user to load and save OWL and RDF ontologies in ontology store 1204, edit and visualize classes and/or properties in classes-instance axiom store 1206, and manage SWRL rules, stored in SWRL rules store 1208, shown in knowledge base 1203. The ontology editor provides for defining logical class characteristics as OWL expressions and editing OWL individuals. Ontology editor 1202 executes reasoners, such as description logic classifiers, via reasoner 1210. The actual reasoning process is conducted through rule engine 1212. The rule engine converts a combination of OWL+SWRL into new facts. The inferences are carried out in inference engine 1214 of the rule engine by matching facts in working memories in accordance with the rules in rule base. Also, if the inference engine infers knowledge using forward chaining, the new knowledge can be used for further inference or querying stored or inferred knowledge.

Some embodiments of the present invention are directed to a CaaS implementation having the ability to process massive amounts of both structured and unstructured data using a big data analytics approach to analyze both explicit and implicit knowledge, bringing this knowledge together to discover new contexts and new facts. In that way, automated policy generation may occur and security control mapping is made possible.

FIG. 12 shows high level components of metadata driven provenance framework. Some embodiments of the present invention are directed to information provenance framework 1300 that assures automated compliance decisions. Framework 1300 includes: compliance metadata store 1302; process execution metadata store 1304; process definition metadata store 1306; metadata analytics module 1308; compliance as a service (CaaS) controller 1310; process model simulation module 1312; and policy generation module 1314. Compliance automation is composed of complex interactions between actionable policies and processes as identified, for example, by process model simulation module 1312. Policy must be decomposable to discrete action plans. Discrete action plans are identified from metadata processed by metadata analytics module 1308 (also referred to as “event cube analytics.” Metadata for policies and processes is stored in various metadata stores, shown as compliance metadata 1302, process execution metadata 1304, and process definition metadata 1306. Those action plans, in turn, are mapped to domain-specific security controls. Processes responsible for interrogating security controls for a current state of the operation, validating compliance conformance, and performing actions to bring components out of non-compliance generate process execution metadata for policy generation module 1314 to trace the execution path. These metadata are analyzed to understand process integrity, process behavior, and accuracy of decisions. Some embodiments of the present invention formalize the learning that arises from these analyses to feed back to CaaS controller 1310. The CaaS controller modifies or controls the process behavior through domain-specific, dynamic policies, or process modification.

Some embodiments of the present invention provide for statically defined or dynamically derived high level business policy and control from business functions, goals, and ideas to drive optimized IT functional model evaluation. In that way, optimized IT security configuration model are derived where business domain policy and control constraints are extracted from external sources (e.g. contracts, manual input).

Some embodiments of the present invention are directed to a comprehensive automation framework to discover and extract non-IT business controls from high level policies that govern business areas, functions, ideas, and goals within a specific organizational context. These high level policies are mapped to IT and security controls sorted according to people, process, technology, and information specification. A weighted compliance score is optimized by business drivers such as cost, revenue, performance, and sustainability.

Some embodiments of the present invention are directed to a comprehensive model driven automation framework to identify, correct, and optimize gaps in an IT functional model, IT realized model and/or IT security configuration model based on enterprise ontology and constraints input from contracts, etc. Similarly, the framework is capable of identifying, correcting, and optimizing gaps in an enterprise ontology, as well as in contracts based on an IT functional model, IT realized model, and/or IT security configuration model.

Some embodiments of the present invention introduce a “compliance-evaluation-process ontology” that permits updating dynamic compliance attributes/constraints from external sources to produce a continually updated degree of (security) performance for the enterprise by imposing those compliance attributes/constraints over the enterprise ontology using the inference engine?

Some embodiments of the present invention are directed to a dynamic enterprise ontology data structure that includes a hierarchical description. The hierarchical description includes: (i) a dynamic Business Operational Meta Model; (ii) dynamic Business Policy and Controls Meta Model; (iii) dynamic Organizational Hierarchy Meta Model; (iv) dynamic Security Architecture Meta Model; (v) dynamic Security Risk Meta Model; and/or (vi) dynamic Security Audit Meta Model.

Some embodiments of the present invention are directed to a compliance-evaluation-process ontology data structure that includes a hierarchical description. The hierarchical description includes: (i) compliance regulation controls; (ii) compliance regulation rules; (iii) compliance regulation constraints; (iv) compliance regulation attributes; (v) dynamic analysis objects with one or more dynamic instances of analysis tasks for performing actions to comply with the dynamic compliance regulation rules; (vi) dynamic instances of evaluation rule based tasks for evaluating the degree to which one or more of the analysis tasks perform to comply with the dynamic compliance regulation rules, the degree being a degree of performance; (vii) dynamic instances of business roles, the business roles performing the analysis tasks and the evaluation tasks to produce the degree of performance; and/or (viii) system inputs for receiving from external sources one or more of the following updates: (a) dynamic compliance regulation rules, (b) dynamic analysis objects, (c) dynamic instance of analysis tasks, (d) dynamic instances of evaluation rule based tasks, and (e) the dynamic instances of business roles.

Some embodiments of the present invention include an inference engine that determines enterprise constraints using inference rules and compliance attributes and/or constraints from the “compliance-evaluation-process ontology” and applies the enterprise constraints to the “dynamic enterprise ontology” to produce an updated degree of performance for the enterprise.

Some embodiments of the present invention apply to external sources including: (i) a business model and control instances derived from contract; and/or (ii) a manual input in the form of business metrics for: (a) performance, (b) business metrics on effect of risk on capital and earning, (c) business metrics for sustainability, (d) business metrics on tolerance for risk, (e) risk scores and vectors, and/or (f) cost of security. External source input allows for, on the initial engagement, the IT expert is utilizing the analytics and/or visualization based on the ontology and the language and/or structure of the contract to make informed decisions (e.g. cost, regulatory, services, and feasibility) and drive negotiated changes in the contract as needed. External source input allows for, in the steady state, the IT expert can use the ontology, visualization, and analytics to report on the organizations compliance levels. External source input allows for, in a reactionary mode (some security incident, or claim by the contract partner), the IT expert can utilize this invention to gather critical information and reports related to, for example, compliance, breach of contract, and residual risk.

Some embodiments of the present invention are directed to an inference engine (e.g. semantic business model inference and translation engine) that reasons over the enterprise ontology constrained by a business model (for example, compliance attributes) and control instances, performed by the “external sources,” and derived from contracts or from manual input. Manual input being in the form of: (i) business metrics for performance; (ii) business metrics on effect of risk on capital and earning; (iii) business metrics for sustainability; (iv) business metrics on tolerance for risk; (v) risk scores and vectors; and/or (vi) cost of security. In that way, outputs are provided regarding the degree of performance, optimized enterprise architecture, optimized security configuration, optimized IT functional model, discrepancy between optimized IT functional model, and/or realized IT model as a report to a user.

For some embodiments of the present invention, the degree of performance includes information about the level, or a measure, to which current security conforms to the latest updated compliance regulations.

Some embodiments of the present invention may include one, or more, of the following features, characteristics and/or advantages: (i) automated policy generation and extraction for IT configurations; (ii) policy mapping to security controls for specific compliance goals, bundled under a class of information service; (iii) reconciliation of policies with IT rules; (iv) factors in impact of business functions, goals, ideas and complex cross business area function and process interactions described in high level business policies to determine the optimized security configuration; (v) analytics-driven “security compliance as a service” that constantly adjusts to varying compliance requirements based on workload, security and compliance requirements; (vi) a policy based, tight integration between CaaS and the rest of the cloud service delivery models to alleviate expectation mismatches that may arise during updates; and/or (vii) maximize IT support using digital knowledge resources while improving efficiency of the skilled human resources.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

what is claimed is:

1. A method comprising:
establishing a first ontology data structure having a hierarchical description including a business-based meta model;
establishing a second ontology data structure having a hierarchical description including a first external compliance dataset;
determining a set of compliance constraints based on a set of inference rules and the first external compliance dataset;
applying the set of compliance constraints to the first ontology data structure to establish an updated first ontology data structure; and
determining a degree of performance based on the updated first ontology data structure;
wherein:
at least the actions of determining a set of compliance constraints and determining a degree of performance are performed by computer software running on computer hardware.

2. The method of claim 1, wherein the business-based meta model includes a business operational meta model, an organizational hierarchy metal model, and a business policy and controls meta model.

3. The method of claim 2, wherein the business-based meta model further includes a security architecture meta model, a security risk meta model, and a security audit meta model.

4. The method of claim 1, wherein the first external compliance dataset includes a first compliance regulation rule, a first analysis task, a first evaluation task, and a first business role;
the first analysis task being an action to comply with the regulation rule;
the first evaluation task being an action to evaluate a degree of performance of the analysis task;
the first business role performing the first analysis task and the first evaluation task.

5. The method of claim 4, further comprising:
receiving a second external compliance dataset from an external source including a second compliance regulation rule, a second analysis task, and a second evaluation task; and
updating the first external compliance dataset with the second external compliance dataset to generate a third external compliance dataset.

6. The method of claim 5, wherein the external source is a business model derived from a contract.

7. The method of claim 1, wherein the degree of performance includes a measure for current security compliance to a first compliance regulation rule.

8. A computer program product comprising a computer readable storage medium having stored thereon:
first program instructions programmed to establish a first ontology data structure having a hierarchical description including a business-based meta model;
second program instructions programmed to establish a second ontology data structure having a hierarchical description including a first external compliance dataset;
third program instructions programmed to determine a set of compliance constraints based on a set of inference rules and the first external compliance dataset;
fourth program instructions programmed to apply the set of compliance constraints to the first ontology data structure to establish an updated first ontology data structure; and
fifth program instructions programmed to determine a degree of performance based on the updated first ontology data structure.

9. The computer program product of claim 8, wherein the business-based meta model includes a business operational meta model, an organizational hierarchy metal model, and a business policy and controls meta model.

10. The computer program product of claim 8, wherein the first external compliance dataset includes a first compliance regulation rule, a first analysis task, a first evaluation task, and a first business role;
the first analysis task being an action to comply with the regulation rule;
the first evaluation task being an action to evaluate a degree of performance of the analysis task;
the first business role performing the first analysis task and the first evaluation task.

11. The computer program product of claim 10, having further stored thereon:
sixth program instructions programmed to receive a second external compliance dataset from an external source including a second compliance regulation rule, a second analysis task, and a second evaluation task; and
seventh program instructions programmed to update the first external compliance dataset with the second external compliance dataset to generate a third external compliance dataset.

12. The computer program product of claim 8, wherein the degree of performance includes a measure for current security compliance to a first compliance regulation rule.

13. A computer system comprising:
a processor(s) set; and
a computer readable storage medium;
wherein:
the processor set is structured, located, connected and/or programmed to run program instructions stored on the computer readable storage medium; and
the program instructions include:
first program instructions programmed to establish a first ontology data structure having a hierarchical description including a business-based meta model;
second program instructions programmed to establish a second ontology data structure having a hierarchical description including a first external compliance dataset;
third program instructions programmed to determine a set of compliance constraints based on a set of inference rules and the first external compliance dataset;
fourth program instructions programmed to apply the set of compliance constraints to the first ontology data structure to establish an updated first ontology data structure; and
fifth program instructions programmed to determine a degree of performance based on the updated first ontology data structure.

14. The computer system of claim 13, wherein the business-based meta model includes a business operational meta model, an organizational hierarchy metal model, and a business policy and controls meta model.

15. The computer system of claim 13, wherein the first external compliance dataset includes a first compliance regulation rule, a first analysis task, a first evaluation task, and a first business role;
the first analysis task being an action to comply with the regulation rule;
the first evaluation task being an action to evaluate a degree of performance of the analysis task;
the first business role performing the first analysis task and the first evaluation task.

16. The computer system of claim 15, having further stored thereon:
sixth program instructions programmed to receive a second external compliance dataset from an external source including a second compliance regulation rule, a second analysis task, and a second evaluation task; and
seventh program instructions programmed to update the first external compliance dataset with the second external compliance dataset to generate a third external compliance dataset.

17. The computer system of claim 16, wherein the external source is a business model derived from a contract.

18. The computer system of claim 13, wherein the degree of performance includes a measure for current security compliance to a first compliance regulation rule.
